(19) United States
(12) Patent Application Publication
(10) Pub. No.: US 2026/0247366 A1
(43) Pub. Date: Aug. 20, 2026

(54) STATUS FEEDBACK METHOD, APPARATUS, AND DEVICE

(71) Applicant: RUIJIE NETWORKS CO., LTD., Fuzhou (CN)

(72) Inventor: Hang YANG, Fuzhou (CN)

(21) Appl. No.: 19/640,376

(22) Filed: Apr. 6, 2026

Related U.S. Application Data
(63) Continuation of application No. PCT/CN2025/097812, filed on May 28, 2025.

(30) Foreign Application Priority Data
May 30, 2024 (CN) 202410696176.9

(51) Int. Cl. H04W 72/0453; H04W 72/23

(52) U.S. Cl. CPC H04W 72/0453; H04W 72/23

(57) ABSTRACT

A status feedback method, apparatus, and non-transitory readable storage medium are provided. The method includes: receiving, by an access point device, a first frame sent by a first station device, the first frame being used to feed back a first status to the access point device; and determining, by the access point device, identification information of the first station device based on a subcarrier set used in a long training field of the first frame and a sequence used in the long training field.

### CROSS-REFERENCE TO RELATED APPLICATIONS

This application is a continuation of International Application No. PCT/CN2025/097812, filed on May 28, 2025, which claims priority to Chinese Patent Application No. 202410696176.9, filed with the China National Intellectual Property Administration on May 30, 2024 and entitled “STATUS FEEDBACK METHOD, APPARATUS, AND DEVICE”, both of which are incorporated herein by reference in their entireties.

### TECHNICAL FIELD

This application relates to the communication field, and in particular, to a status feedback method, an apparatus, and a device.

### BACKGROUND

In the related art, an access point (AP) inquires whether a station (STA) has a status to be reported through a polling frame (for example, a null data physical layer protocol data unit (NDP) feedback report poll (NFRP) frame or a buffer status report poll (BSRP) frame). STAs that have a status to be reported can send feedback frames, and the AP determines which STAs have provided feedback and the status of the STAs based on the subcarrier occupancy of the feedback frames sent by the STAs. However, under this mechanism, the quantity of STAs that can send feedback frames is limited by the quantity of subcarriers. Therefore, how to improve the polling efficiency is an urgent problem to be resolved.

### SUMMARY

This application provides a status feedback method, an apparatus, and a device.

According to a first aspect, a status feedback method is provided, including:
receiving, by an access point device, a first frame sent by a first station device, the first frame being used to feed back a first status to the access point device; and
determining, by the access point device, identification information of the first station device based on a subcarrier set used in a long training field of the first frame and a sequence used in the long training field.

According to a second aspect, a status feedback method is provided, including:
sending, by a first station device, a first frame to an access point device, the first frame being used to feed back a first status to the access point device; where
a long training field of the first frame is transmitted using a first subcarrier set among N subcarrier sets, where the first subcarrier set is determined based on identification information of the first station device, and N is a positive integer greater than or equal to 1; where
the long training field is obtained by filling based on a first sequence, the first sequence being determined based on the identification information of the first station device.

According to a third aspect, a wireless communication apparatus is provided, including:
a receiving module, configured to receive a first frame sent by a first station device, the first frame being used to feed back a first status to an access point device; and
a processing module, configured to determine identification information of the first station device based on a subcarrier set used in a long training field of the first frame and a sequence used in the long training field.

According to a fourth aspect, a wireless communication apparatus is provided, including:
a sending module, configured to send a first frame to an access point device, the first frame being used to feed back a first status to the access point device; where
a long training field of the first frame is transmitted using a first subcarrier set among N subcarrier sets, where the first subcarrier set is determined based on identification information of a station device, and N is a positive integer greater than 1; where
the long training field is obtained by filling based on a first sequence, the first sequence being determined based on the identification information of the station device.

According to a fifth aspect, an access point device is provided, including a processor and a memory. The memory is configured to store a computer program, and the processor is configured to invoke and run the computer program stored in the memory to perform the method according to the first aspect or any implementation thereof.

According to a sixth aspect, a station device is provided, including a processor and a memory. The memory is configured to store a computer program, and the processor is configured to invoke and run the computer program stored in the memory to perform the method according to the second aspect or any implementation thereof.

According to a seventh aspect, a chip is provided, configured to implement the method according to any one of the first aspect and the second aspect or any implementation thereof. Specifically, the chip includes a processor configured to invoke and run a computer program from a memory, so that a device installed with the chip performs the method according to any one of the first aspect and the second aspect or any implementation thereof.

According to an eighth aspect, a readable storage medium is provided, configured to store a computer program. The computer program causes a computer to perform the method according to any one of the first aspect and the second aspect or any implementation thereof.

According to a ninth aspect, a computer program product is provided, including computer program instructions. The computer program instructions cause a computer to perform the method according to any one of the first aspect and the second aspect or any implementation thereof.

According to a tenth aspect, a computer program is provided. When the computer program is run on a computer, the computer performs the method according to any one of the first aspect and the second aspect or any implementation thereof.

With the foregoing technical solutions, the access point device can identify the identification information of the station device based on the subcarrier set used in the long training field of the first frame sent by the station device and the sequence used in the long training field, thereby learning that the station device corresponding to the identification information needs to feed back the first status. In this way, the quantity of station devices that may be inquired in one polling is related to the total quantity of subcarrier sets and the total quantity of sequences. Therefore, based on the polling solution in the embodiments of this application, the quantity of station devices that may provide feedback in one polling is expanded, improving the polling efficiency.

### BRIEF DESCRIPTION OF DRAWINGS

FIG. 1 is a schematic diagram of a communication system applicable to embodiments of this application.

FIG. 2 is a schematic diagram of data transmission based on a pre-emption mechanism.

FIG. 3 is a schematic diagram of a general trigger frame format.

FIG. 4 is a schematic diagram of a format of a common info field of a trigger frame.

FIG. 5 is a schematic diagram of a format of a user info list field of a trigger frame.

FIG. 6 is a schematic diagram of a frame structure of an NDP frame.

FIG. 7 is a schematic diagram of an allocation manner of subcarrier sets for a 20 MHz bandwidth in an NFRP mechanism.

FIG. 8 is a schematic diagram of pre-emption request inquiry based on an NFRP mechanism.

FIG. 9 is a schematic diagram of a status feedback method according to an embodiment of this application.

FIG. 10 is a schematic structural diagram of a user information field of a second frame according to an embodiment of this application.

FIG. 11 is an overall flowchart of a status feedback method according to an embodiment of this application.

FIG. 12 is a schematic diagram of an allocation manner of subcarrier sets according to an embodiment of this application.

FIG. 13 is a schematic diagram of an STA side sending a pre-emption request and an AP side detecting the pre-emption request in a 20 MHz bandwidth when Nis 34.

FIG. 14 is a schematic block diagram of a station device according to an embodiment of this application.

FIG. 15 is a schematic block diagram of an access point device according to an embodiment of this application.

FIG. 16 is a schematic block diagram of a communication device according to an embodiment of this application.

FIG. 17 is a schematic block diagram of a chip according to an embodiment of this application.

FIG. 18 is a schematic block diagram of a communication system according to an embodiment of this application.

### DESCRIPTION OF EMBODIMENTS

The following describes the technical solutions in the embodiments of this application with reference to the accompanying drawings in the embodiments of this application. Apparently, the described embodiments are only some but not all of the embodiments of this application. All other embodiments obtained by persons of ordinary skill in the art based on the embodiments of this application without creative efforts shall fall within the protection scope of this application.

It should be noted that in this specification, the terms “include”, “comprise”, or any other variants thereof are intended to cover a non-exclusive inclusion, such that a process, method, article, or apparatus that includes a series of elements includes not only those elements but also other elements that are not expressly listed, or further includes elements inherent to such process, method, article, or apparatus. In addition, the terms “first”, “second”, and so on in this specification are used only to distinguish between different objects but do not indicate a particular order.

It should be noted that in the embodiments of this application, “at least one” means one or more, “a plurality of” means two or more, and “at least two” means two or more. “At least one of the following” or similar expressions may represent any combination thereof. For example, at least one of a, b, or c may mean a, b, c, “a and b”, “a and c”, “b and c”, or “a, b, and c”.

It should be noted that in the embodiments of this application, “and/or” indicates that three relationships of the connected objects may exist, for example, “A and/or B” indicates the following three cases: only A, only B, or both A and B. The character “/” generally indicates an “or” relationship between the contextually associated objects.

It should be understood that “indicate” mentioned in the embodiments of this application may be a direct indication or an indirect indication. For example, A indicates B, which may mean that A directly indicates B, for example, B may be obtained from A; or may mean that A indirectly indicates B, for example, A indicates C, and B may be obtained from C, for example, B and C have an association relationship.

The technical solution provided in the embodiments of this application may be applied to a wireless local area network (WLAN) system, such as a Wi-Fi protocol. The Wi-Fi protocol comprises 802.11 series of protocols, such as 802.11a protocol, 802.11ax protocol, 802.11ac protocol, 802.11b protocol, 802.11be protocol, 802.11g protocol, 802.11n protocol, 802.11bn protocol, or a next-generation protocol.

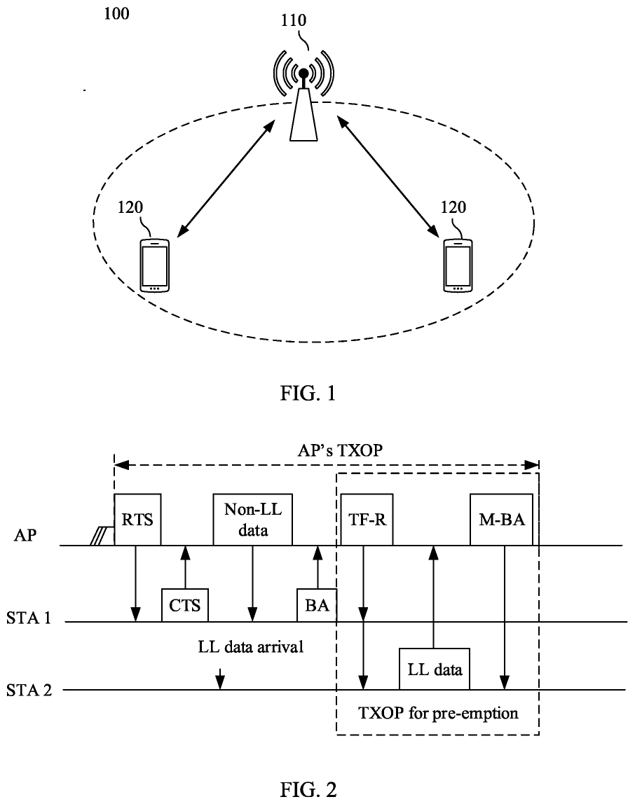

FIG. 1 is a schematic structural diagram of a communication system 100 applicable to embodiments of this application. The communication system 100 may include an access point (AP) 110 and a station (STA) 120. The station 120 may access the network via the access point 110.

The access point may support communication or sensing based on a Wi-Fi protocol, such as 802.11a protocol, 802.11ax protocol, 802.11ac protocol, 802.11b protocol, 802.11be protocol, 802.11g protocol, 802.11n protocol, 802.11bn protocol, or a next-generation protocol.

The station may support communication or sensing based on a Wi-Fi protocol, such as 802.11a protocol, 802.11ax protocol, 802.11ac protocol, 802.11b protocol, 802.11be protocol, 802.11g protocol, 802.11n protocol, 802.11bn protocol, or a next-generation protocol.

The communication in the communication system 100 may be communication between an access point and a station, between a station and a station, or between an access point and an access point.

The access point acts as a bridge connecting a wired network and a wireless network, and its main function is to connect various wireless network clients together and then access the Ethernet via the wireless network.

The station is also referred to as a non-access point station (non-AP STA), and the access point is also referred to as an access point station (AP STA), that is, the access point is also a type of station in a sense.

In some scenarios, the access point and station may be devices applied in the internet of vehicles, nodes or sensors in the internet of things (IoT), smart cameras, smart remote controls, or smart water and electricity meters in smart home, sensors in smart city, or the like.

In some scenarios, the access point may be a terminal device (such as a mobile phone) with a Wi-Fi chip or a network device (such as a router).

In the embodiments of this application, the station may be a mobile phone, a tablet computer, a computer, a virtual reality (VR) device, an augmented reality (AR) device, a wireless device in industrial control (industrial control), a set-top box, a wireless device in self driving (self driving), an in-vehicle communication device, a wireless device in remote medical treatment (remote medical), a wireless device in smart grid (smart grid), a wireless device in transportation safety (transportation safety), a wireless device in smart city (smart city), a wireless device in smart home (smart home), a wireless communication chip, or the like, supporting WLAN or Wi-Fi technologies.

It should be understood that FIG. 1 shows only one access point and two stations. Optionally, the communication system 100 may include a plurality of access points or another quantity of stations, which is not limited in the embodiments of this application.

Optionally, the communication system 100 may further include other devices, such as a network controller, a gateway, or other network entities, which are not limited in this application.

To facilitate understanding of the embodiments of this application, a pre-emption (Pre-emption) mechanism related to this application is described.

In some scenarios, reducing the transmission delay of low-latency data by 25% is one of the key research directions of standard protocols. The pre-emption mechanism may greatly reduce the transmission delay of low-latency data and is a research hotspot. The pre-emption mechanism allows a device in the communication system to pre-empt a channel upon arrival of low-latency (LL) data and start low-latency data transmission, so that low-latency data does not need to wait for completion of the current data transmission, thereby reducing the transmission delay of low-latency data.

FIG. 2 is a schematic diagram of data transmission based on a pre-emption mechanism. As shown in FIG. 2, an AP obtains a transmission opportunity (TXOP) for sending normal data (also referred to as non-LL data (Non-LL data)) to STA 1. Within this TXOP, when low-latency data arrives, a sender (that is, STA 2) of low-latency data may interrupt the current data transmission (that is, non-LL data transmission from AP to STA 1) through a specific mechanism, and thus pre-empts the channel and starts low-latency data transmission, reducing the transmission delay of low-latency data.

The pre-emption process may include two parts: pre-emption demand inquiry (or pre-emption request inquiry) and uplink data transmission.

Pre-emption demand inquiry: The AP sends a broadcast frame (such as an NFRP frame or a BSRP frame) to STA to inquire whether the STA has an uplink pre-emptive (or low-latency data) transmission requirement. After receiving the broadcast frame, the STA responds with an NDP frame to the AP after one short interframe space (SIFS). The NDP frame includes an association identifier (AID) information of the STA and an indication of whether to initiate pre-emptive transmission. The AP analyzes the received NDP frame to obtain the AID and related information of the STA that needs to initiate pre-emptive transmission.

Uplink data transmission: After obtaining the AID and related information of the STA, the AP sends a trigger (Trigger) frame to the STA that sends a pre-emptive transmission requirement, allocates an uplink resource unit (RU) for the STA, instructs the STA to send uplink data, and starts pre-emptive (or low-latency data) transmission.

In some scenarios, a pre-emption demand inquiry mechanism may be implemented based on an NFRP mechanism. The NFRP mechanism is described below. The NFRP mechanism is a trigger (Trigger) frame mechanism used by the AP to inquire about a buffer (Buffer) status of the STA.

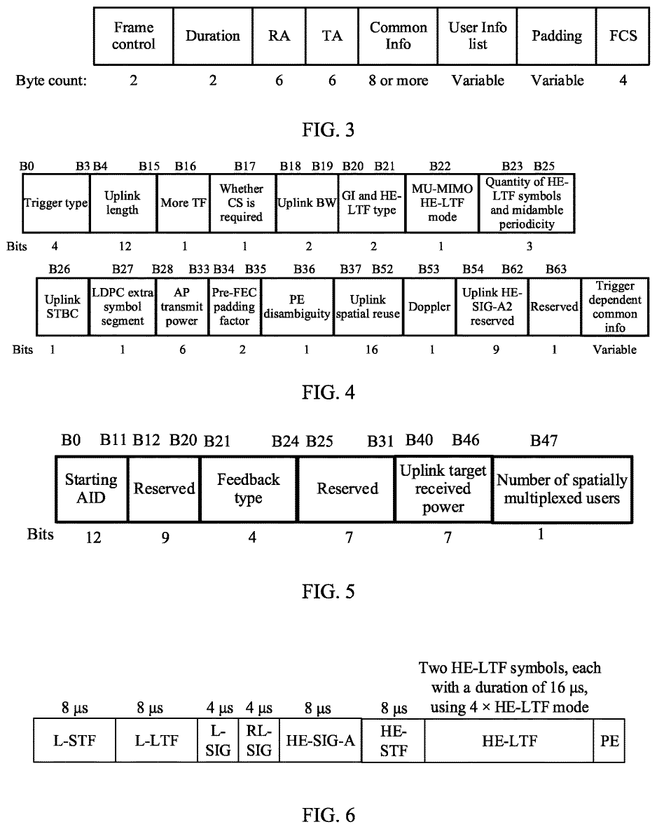

FIG. 3 is a general trigger frame format in 802.11ax. As shown in FIG. 3, the trigger frame may include the following fields (field).

Frame control (occupying 2 bytes), duration (duration) (occupying 2 bytes), receiving address (RA) (occupying 6 bytes), transmission address (TA) (occupying 6 bytes), common info (Common Info) (occupying 8 or more bytes), user info list (User Info list) (occupying variable (variable) bytes), padding (padding) (occupying variable (variable) bytes), and frame check sequence (FCS) (occupying 4 bytes). The TA field is an AID of a sender of the trigger frame, for example, the AID of the AP. The RA field is used to indicate an AID of a receiver of the trigger frame. When the trigger frame is of NFRP type, the RA is a broadcast address (broadcast address), indicating that all STAs receive and demodulate this frame.

FIG. 4 shows a format of the common info field (Common Info field) of a trigger frame. As shown in FIG. 4, the common info field includes the following subfields (subfield):

trigger type (Trigger Type) (occupying 4 bits), uplink length (UL Length) (occupying 12 bits), more trigger frames (TF) (occupying 1 bit), whether carrier sense (CS) is required (occupying 1 bit), uplink bandwidth (BW) (occupying 2 bits), guard interval (GI) and high efficiency long training field (HE-LTF) type (occupying 2 bits), multiple users multiple-in multiple-out (MU-MIMO) HE-LTF mode (occupying 1 bit), quantity of HE-LTF symbols and midamble periodicity (occupying 3 bits), uplink space time block code (STBC) (occupying 1 bit), low-density parity check (LDPC) extra symbol segment (occupying 1 bit), AP transmit power (occupying 6 bits), pre-forward error correction (Pre-FEC) padding factor (occupying 2 bits), packet extension (PE) disambiguity (disambiguity) (occupying 1 bit), uplink spatial reuse (occupying 16 bits), doppler (doppler) (occupying 1 bit), uplink high efficiency-signal field-A2 (HE-SIG-A2) reserved (occupying 9 bits), reserved (occupying 1 bit), and trigger dependent common info (Trigger Dependent Common Info) (occupying variable (variable) bits).

The trigger type subfield is used to identify the type of the trigger frame. Table 1 shows a correspondence between values of the trigger type subfield and types of the trigger frame.

TABLE 1

| Value of trigger type subfield | Type of trigger frame |
|---|---|
| 0 | Basic (Basic) |
| 1 | Beamforming report poll (BFRP) |
| 2 | MU-BAR |
| 3 | Multiple users request-to-send (MU-RTS) |
| 4 | BSRP |
| 5 | GCR MU-BAR |
| 6 | Bandwidth query report poll (BQRP) |
| 7 | NFRP |
| 8-15 | Reserved |

When detecting a trigger frame of NFRP type, the STA may process the frame based on information in the user info list field of the NFRP frame. FIG. 5 is a structural diagram of the user info list field of an NFRP frame. As shown in FIG. 5, the user info list field includes the following subfields (subfield):
starting AID (starting AID) (occupying 12 bits), reserved (occupying 9 bits), feedback type (Feedback Type) (occupying 4 bits), reserved (occupying 7 bits), uplink target received power (occupying 7 bits), and number of spatially multiplexed users (Number of spatially Multiplexed Users) (occupying 1 bit).

The starting AID subfield is used to indicate the starting AID of the current NFRP polling. In one NFRP polling, only several STAs following the starting AID may send a response.

After the AP sends the NFRP frame, the STA that receives the NFRP frame may respond with an NDP frame to the AP. FIG. 6 is a frame structure of an NDP frame.

As shown in FIG. 6, the NDP frame may include the following fields:
legacy short training field (L-STF);
legacy long training field (L-LTF);
legacy signal field (L-SIG);
repeated L-SIG (RL-SIG), which is a repetition of L-SIG;
high efficiency (HE) signal A (HE-SIG-A);
high efficiency short training field (HE-STF);
high efficiency long training field (HE-LTF); and
packet extension (PE) field.

It should be understood that the fields included in the frame format and their positions and lengths shown in FIGS. 3 to 6 are merely examples, which are not limited in this application.

In NDP frames responded by a plurality of STAs to the same NFRP frame, all field contents except the HE-LTF field are the same. Therefore, when the plurality of NDP frames overlap, no interference is generated. The HE-LTF field is transmitted using the principle of frequency division. The details are described below.

The specific operation of the STA to generate the HE-LTF field in the NDP frame is as follows.

1. The STA determines, based on the starting AID and its own AID, whether it is within the range of STAs required to respond to the NFRP frame. If it is not within the STA range, the STA discards the NFRP frame. If it is within the STA range, the STA proceeds to the next step.

2. The STA determines the index (RU_TONE_SET_INDEX) of the subcarrier set corresponding to its own AID according to the method specified in the protocol. The subcarrier set is the one selected by the STA with this AID when sending the HE-LTF field in the NDP frame.

3. The STA determines the selected subcarrier set based on its own buffer status and a threshold (the threshold is indicated by a beacon frame). For example, if the buffer exceeds the threshold, the STA selects a subcarrier set with the feedback status (FEEDBACK_STATUS) being 1 to fill the HE-LTF sequence, that is, the HE-LTF sequence is transmitted on the subcarrier set with FEEDBACK_STATUS being 1.

Alternatively, if the buffer does not exceed the threshold, the STA selects a subcarrier set with FEEDBACK_STATUS being 0 to fill the HE-LTF sequence, that is, the HE-LTF sequence is transmitted on the subcarrier set with FEEDBACK_STATUS being 0.

4. After filling the corresponding subcarrier with the HE-LTF filling sequence, the STA sends the NDP frame to the AP. For all STAs, the filling sequence is fixed and identical.

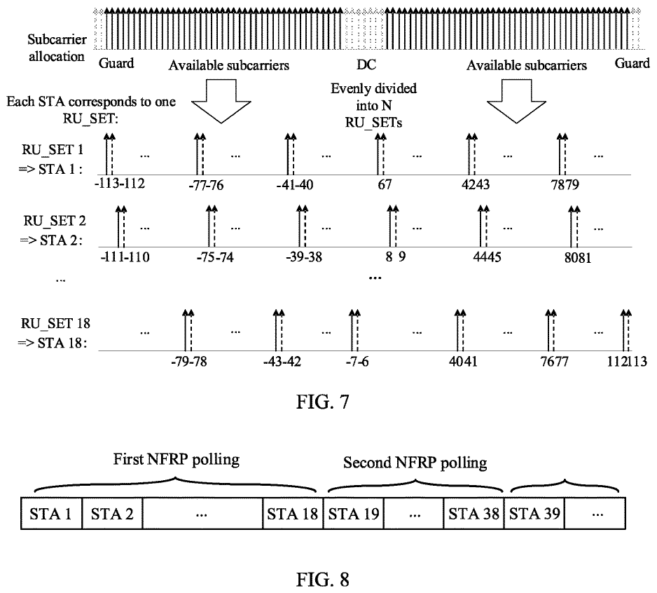

It can be seen that different STAs identify their own AID and buffer status by sending HE-LTF using different subcarrier sets. Table 2 and FIG. 7 illustrate an allocation scheme of subcarrier sets for a 20 MHz bandwidth. The allocation principle of subcarrier sets is similar for other bandwidths, and only 20 MHz is taken as an example herein.

TABLE 2

| Subcarrier | Subcarrier numbers used by HE-LTF in NDP | |
|---|---|---|
| set | Buffer exceeding | Buffer not exceeding |
| (RU_SET) | threshold | threshold |
| 1 | −113, −77, −41, 6, 42, 78 | −112, −76, −40, 7, 43, 79 |
| 2 | −111, −75, −39, 8, 44, 80 | −110, −74, −38, 9, 45, 81 |
| . . . | . . . | . . . |
| 18 | −79, −43, −7, 40, 76, 112 | −78, −42, −6, 41, 77, 113 |

As shown in FIG. 7, available subcarriers may be divided into 18 subcarrier sets (RU_SET). Each STA corresponds to one RU_SET, and one RU_SET includes two subcarrier groups, corresponding to two buffer statuses of the STA, that is, buffer exceeding the threshold (the buffer status is 1) and buffer not exceeding the threshold (the buffer status is 0). For example, as shown in FIG. 7 and Table 2, RU_SET 1 may include subcarrier group 1 (−113, −77, −41, 6, 42, 78) and subcarrier group 2 (−112, −76, −40, 7, 43, 79), corresponding to the two buffer statuses, respectively.

When the STA has a pre-emption demand, the STA may respond with an NDP frame. The HE-LTF field in the NDP frame may be transmitted using the subcarrier set corresponding to the AID of the STA. For example, when the buffer status is 1, transmission is performed using the subcarrier group corresponding to buffer status 1 in the subcarrier set, or when the buffer status is 0, transmission is performed using the subcarrier group corresponding to buffer status 0 in the subcarrier set. The HE-LTF field is filled with a fixed sequence.

Therefore, after receiving the NDP frame, the AP may determine the AIDs of the STAs that have responded with NDP and the buffer status of the STAs, based on the subcarrier occupancy of HE-LTF, and further determine whether to start uplink transmission.

However, the foregoing NFRP mechanism has some disadvantages.

Taking 20 MHz as an example, the protocol prepares 12 subcarriers for each STA for NDP response (corresponding to two buffer statuses, each occupying six subcarriers). Therefore, in each NFRP polling, limited by the quantity of subcarriers, a maximum of 18 STAs can respond NDP.

In the pre-emption demand polling mechanism, if the quantity of STAs is large, the AP needs to send a plurality of NFRP frames to perform pre-emption demand inquiry for all STAs. For example, as shown in FIG. 8, if pre-emption demand inquiry needs to be performed for 39 or more STAs, the AP needs to send at least three NFRP frames, which causes excessive signaling transmission delay and increases transmission delay of low-latency data. In addition, since the pre-emption mechanism is performed during the transmission of normal data, even if there is no low-latency data, an excessively long inquiry time reduces the transmission efficiency of the currently pre-empted data. Similar problems may exist in other polling scenarios with a plurality of STAs.

Therefore, how to improve the polling efficiency (for example, improving the pre-emption demand inquiry efficiency to reduce the low-latency data transmission delay) is an urgent problem to be resolved.

In view of this, the embodiments of this application provide a technical solution. A plurality of subcarrier sets may be divided, each corresponding to a group of station devices. A group of station devices using the same subcarrier set may be distinguished by different sequences, where the sequences are orthogonal, thereby reducing interference between signals. When responding to a polling frame (for example, pre-emption demand polling frame), a station device may fill a corresponding sequence in a subcarrier set determined based on identification information of the station device, serving as a status feedback signal (for example, pre-emption request signal). Correspondingly, an access point device may identify identification information of a station device sending a sequence on the subcarrier set by detecting the subcarrier set and sequence used by the status feedback signal, and thus learn which station devices have a status feedback demand (for example, pre-emptive transmission requirement or low-latency data transmission requirement). Therefore, the technical solution provided in the embodiments of this application may identify different station devices by using subcarrier sets and sequences, so that one subcarrier set may accommodate a plurality of station devices to send status feedback signals, which increases the quantity of station devices covered by one polling.

The embodiments of this application further design a resource allocation method in a polling mechanism (for example, pre-emption request inquiry mechanism). For example, a plurality of optional resource allocation schemes are designed according to anti-interference capability of signals and/or computational complexity of detection on an AP side, for use by the AP side under different interference conditions and/or detection performance conditions.

The embodiments of this application further design a mapping method between identification information of station devices and subcarrier sets and shift information of sequences in a polling mechanism (for example, pre-emption request inquiry mechanism). The mapping method can ensure that a plurality of station devices may be evenly allocated to different subcarrier sets, and a group of station devices may use appropriate shift information to ensure the orthogonality of sequences used by station devices using the same subcarrier set, thereby reducing interference between signals.

The embodiments of this application further provide a frame structure design for a polling frame (for example, pre-emption request poll) in a polling mechanism (for example, pre-emption request inquiry mechanism). The frame structure can ensure that the receiver (that is, station device) of the polling frame learns that the polling frame is used to inquire whether status feedback is required, and learns the resource information allocated by the access point device to the station device for status feedback, such as subcarrier information and sequence information.

The technical solution of this application is described in detail below through specific embodiments. The above related technologies, as optional solutions, may be combined with the technical solution of the embodiments of this application in any way, and all such combinations fall within the protection scope of the embodiments of this application.

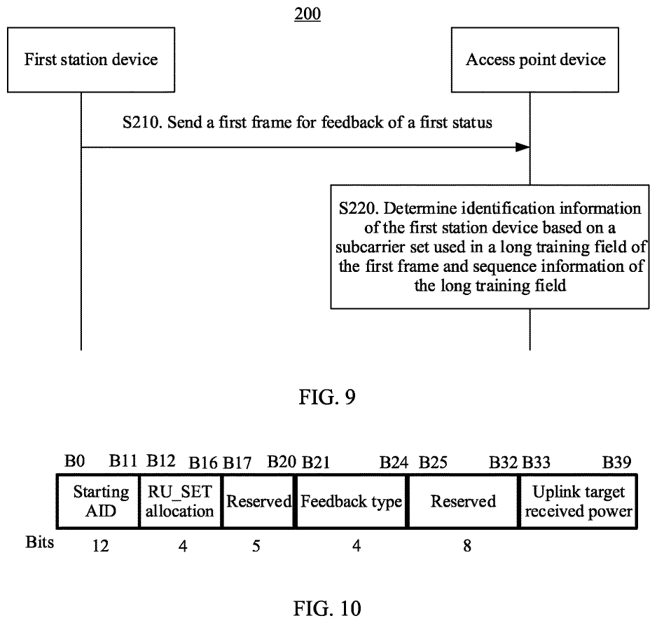

FIG. 9 is a schematic interaction diagram of a status feedback method 200 according to an embodiment of this application. As shown in FIG. 9, the method 200 includes at least part of the following.

S210. A first station device sends a first frame to an access point device.

Correspondingly, the access point device receives the first frame sent by the first station device.

S220. The access point device determines identification information of the first station device based on a subcarrier set used in a long training field of the first frame and a sequence used in the long training field.

Optionally, in some embodiments, the method 200 may further include the following.

Other station devices than the first station device send a first frame to the access point device. Correspondingly, the access point device may receive the first frame sent by the other station devices.

The access point device determines identification information of the other station devices based on a subcarrier set used in a long training field of the first frame sent by the other station devices and a sequence used in the long training field.

It should be understood that the quantity of station devices sending the first frame to the access point device is not limited in the embodiments of this application. For example, the quantity may be one or plurality, which is not limited in this application. The first station device is described as an example below, but this application is not limited thereto.

Optionally, the station device in the embodiments of this application may be the station 120 in the communication system shown in FIG. 1, or called non-AP STA. For example, the first station device may be but is not limited to various types of the station 120. The access point device in the embodiments of this application may be the access point 110 in the communication system shown in FIG. 1, or called AP STA. For example, the access point device may be but is not limited to various types of the access point 110.

In some embodiments, the first frame is used to feed back (or respond or report) a first status to the access point device.

Optionally, the first status comprises a pre-emption request (or pre-emptive transmission requirement), a low-latency data transmission request (or low-latency data transmission requirement), or feedback of another status or request, which is not limited in this application.

That is, the first frame may be used for the station device to feed back a pre-emption request (meaning that the station device has a pre-emptive transmission requirement) or a low-latency data transmission request (meaning that the station device has a low-latency data transmission requirement) to the access point device.

The first frame being used for the station device to feed back a pre-emption request to the access point device is described as an example below, but this application is not limited thereto. The feedback principle of other statuses or requests is similar.

It should be understood that the long training field in the embodiments of this application may include existing long training fields in the 802.11 standard, or may further include new long training fields introduced with the evolution of the standard, or other fields with similar functions, or the long training field whose name may change with the evolution of the standard, which also falls within the protection scope of this application.

In some specific embodiments, the long training field comprises at least one of the following:
high efficiency long training field (HE-LTF);
extremely high throughput long training field (EHT-LTF); and
ultra-high reliability long training field (UHR-LTF).

In some embodiments, the first frame may be an NDP frame, but this application is not limited thereto.

It should be noted that in the embodiments of this application, the subcarrier set is also referred to as a resource unit set (RU_SET).

In some embodiments, the subcarrier set and sequence used in the long training field of the first frame sent by the station device may be determined based on the identification information of the station device. For example, for the first station device, the long training field of the first frame is transmitted using a first subcarrier set among N subcarrier sets, where the first subcarrier set is determined based on the identification information of the first station device, and N is a positive integer greater than or equal to 1. The long training field of the first frame is obtained by filling based on a first sequence, where the first sequence is determined based on the identification information of the first station device.

Correspondingly, the access point device may identify the identification information of the station device that sends the first frame by detecting the subcarrier set and sequence used in the long training field of the first frame sent by the station device.

In the embodiments of this application, the identification information of the station device comprises an AID.

In some embodiments, each of the N subcarrier sets may correspond to a group of station devices, where the group of station devices may include one or more station devices. Each group of station devices may use the corresponding subcarrier set to send the long training field, where different station devices in each group of station devices use different sequences to send the long training field. For example, the first station device sends the long training field using the first subcarrier set, and the sequence used by the first station device to send the long training field is the first sequence. For another example, a second station device sends a long training field using a second subcarrier set, and the sequence used by the second station device to send the long training field is a second sequence. The first sequence and the second sequence are different, and/or the first subcarrier set and the second subcarrier set are different, meaning that at least one of the subcarrier set and sequence used by the first station device to send the long training field is different. For example, the first sequence and the second sequence are different, and the first subcarrier set and the second subcarrier set are the same. In this case, the first station device and the second station device are different station devices in a group of station devices that use the same subcarrier set. For another example, the first sequence and the second sequence are the same, and the first subcarrier set and the second subcarrier set are different. In this case, the first station device and the second station device are station devices in different groups. For another example, the first sequence and the second sequence are different, and the first subcarrier set and the second subcarrier set are different. In this case, the first station device and the second station device are station devices in different groups.

Therefore, based on this pre-emption request feedback solution, for one pre-emption request polling, the total quantity of station devices supporting feedback of pre-emption requests is related to the total quantity of subcarrier sets and the total quantity of sequences.

For example, if there are N subcarrier sets, one subcarrier set may accommodate a plurality of station devices using different sequences for feedback of pre-emption requests. For example, it may accommodate station devices using K orthogonal sequences for feedback of pre-emption requests. Then, the quantity of station devices that may be inquired in one pre-emption request polling is N*K. Therefore, based on the pre-emption request polling solution of the embodiments of this application, the quantity of station devices that may be covered in one polling is increased.

It should be noted that in the embodiments of this application, that different station devices in each group of station devices use different sequences to send the long training field may mean that: the original sequences (or basic sequences) corresponding to the sequences used by different station devices to send the long training field are different (for example, roots are different), and/or shift information of the sequences is different. In a specific implementation, the original sequences corresponding to the sequences used by different station devices using the same subcarrier set to send the long training field are the same (for example, roots are the same), but shift information is different, meaning that the sequences used by different station devices to send the long training field may be obtained by shifting the same original sequence with different shift information.

For example, that the first sequence and the second sequence are different may mean that: the original sequences corresponding to the first sequence and the second sequence are the same, but shift information of the first sequence and the second sequence is different. That is, the first sequence and the second sequence are obtained by shifting the same original sequence with different shift information. Alternatively, the original sequences corresponding to the first sequence and the second sequence are different. Optionally, shift information of the first sequence and the second sequence may be the same or different.

In some embodiments, the N subcarrier sets may be configured by the access point device or predefined, which is not limited in this application.

In some embodiments, all available subcarriers in one channel (for example, Wi-Fi channel) may be divided to obtain the N subcarrier sets, where one subcarrier set includes a plurality of subcarriers.

For example, for a 20 MHz channel, subcarriers with indices from −122 to −4 and 4 to 122 are available subcarriers, totaling 238 subcarriers. The 238 subcarriers may be divided into N subcarrier sets, for example, divided into 34 subcarrier sets, each including 7 subcarriers.

It should be understood that in the embodiments of this application, that the long training field of the first frame is transmitted using the first subcarrier set and that the long training field is obtained by filling based on the first sequence may be understood as follows: the long training field of the first frame is obtained by filling the first subcarrier set among the N subcarrier sets using the first sequence. For the first frame sent by the first station device, energy or signal exists on the first subcarrier set where the long training field is located, and no energy or no signal exists on other subcarrier sets.

In some embodiments, the quantity of subcarriers included in the subcarrier set used by the terminal device to send the long training field is equal to the length of the sequence used in the long training field. For example, one sequence symbol is filled in each subcarrier in the subcarrier set to obtain the long training field.

For example, the sequence length of the first sequence is equal to the quantity of subcarriers included in the first subcarrier set. The first station device may obtain the long training field by filling one sequence symbol of the first sequence in each subcarrier in the first subcarrier set.

In some embodiments, the maximum quantity of station devices that may use one subcarrier set is related to the sequence length. For example, if the sequence length is K, at most K station devices may use the same subcarrier set, where each station device corresponds to one sequence, and the sequences used by the K station devices are orthogonal.

In some embodiments of this application, before S210, the method 200 further includes the following.

The access point device sends a second frame, the second frame being used to inquire whether at least one station device needs to feed back the first status, for example, whether there is a pre-emption request, whether there is a pre-emption demand, or whether there is a low-latency data transmission requirement. The at least one station device includes the first station device.

In some embodiments, when the second frame is used to inquire whether the at least one station device has a pre-emption request, has a pre-emption demand, or has a low-latency data transmission requirement, the second frame is also referred to as pre-emption request poll (PRP) frame, pre-emption demand polling frame, or low-latency data transmission request polling frame.

In some embodiments, the second frame includes a trigger type field, the trigger type field being used to indicate that the second frame is used to inquire whether the at least one station device needs to feed back the first status, for example, whether there is a pre-emption request, whether there is a pre-emption demand, or whether there is a low-latency data transmission requirement.

The second frame being used to inquire whether the at least one station device has a pre-emption request is described as an example below. The second frame may alternatively be used to inquire whether the at least one station device has a feedback demand for other statuses or requests, but this application is not limited thereto.

In some embodiments, the second frame may be a trigger frame. Optionally, the second frame may reuse an existing trigger type, for example, NFRP frame type, or a new trigger type may be defined for pre-emption request polling, for example, a new pre-emption request poll (PRP) type is defined. In this case, the second frame is also referred to as pre-emption request polling frame.

Optionally, the common info field (Common Info field) in the second frame includes the trigger type (Trigger Type) field. When the value of the trigger type field is a first value, it is used to indicate that the second frame is used to inquire whether the station device has a pre-emption request, or that the second frame is a pre-emption request inquiry frame. Optionally, the first value may be a reserved value, for example, any value from 8 to 15. In a specific example, the first value may be 8. Table 3 shows a correspondence between values of the trigger type field and corresponding frame types.

TABLE 3

| Value of trigger type field | Trigger frame type |
|---|---|
| 0 | Basic (Basic) |
| 1 | BFRP |
| 2 | MU-BAR |
| 3 | MU-RTS |
| 4 | BSRP |
| 5 | GCR MU-BAR |
| 6 | BQRP |
| 7 | NFRP |
| 8 | PRP |
| 9-15 | Reserved |

In some embodiments, the second frame includes first indication information, where the first indication information is used to indicate a resource allocation allocated by the access point device for the at least one station device to feed back the pre-emption request, and the resource allocation includes a subcarrier configuration and a sequence configuration. Optionally, the subcarrier configuration may be used to configure the quantity of subcarrier sets and/or subcarriers included in each subcarrier set. Optionally, the sequence configuration may be used to configure the sequence length and/or root.

In some specific embodiments, the resource allocation comprises at least one of the following:
quantity N of subcarrier sets, a subcarrier number contained in each subcarrier set, a sequence length, and a root for generating a sequence.

In the embodiments of this application, the subcarrier number is also referred to as subcarrier serial number or subcarrier index.

Optionally, the root for generating a sequence may be configured for the N subcarrier sets, that is, all station devices using the N subcarrier sets use the same root to generate the filling sequence of the corresponding long training field.

Optionally, the root for generating a sequence is at the granularity of subcarrier set. For example, a corresponding root is configured for each subcarrier set, so that station devices using different subcarrier sets use the corresponding root to generate the filling sequence of the corresponding long training field.

It should be noted that in the embodiments of this application, the first indication information may explicitly indicate a specific resource allocation, or may implicitly indicate a resource allocation. For example, it may be used to indicate a first resource allocation index, where the first resource allocation index corresponds to one of a plurality of resource allocations, and each resource allocation corresponds to one resource allocation index.

In some embodiments, a plurality of resource allocations may be predefined or preconfigured, each corresponding to one resource allocation index, where the first resource allocation index is one of these resource allocation indices. Optionally, different resource allocations differ in at least one of the grouping manner of subcarrier sets, sequence length, and root.

Optionally, a plurality of resource allocations may be set according to anti-interference capability of signals and/or computational complexity. For example, a plurality of resource allocations correspond to different subcarrier set grouping schemes or sequence lengths, for use by the access point device under different interference conditions and/or detection performance conditions.

For example, the plurality of resource allocations include a first resource allocation and a second resource allocation, where the sequence length corresponding to the first resource allocation is a first length, the sequence length corresponding to the second resource allocation is a second length, and the first length is greater than the second length. In this case, the length of the sequence generated based on the first resource allocation is greater than that of the sequence generated based on the second resource allocation, the anti-interference capability of the sequence generated based on the first resource allocation is higher than that of the sequence generated based on the second resource allocation, and the detection complexity of the sequence generated based on the first resource allocation is higher than that of the sequence generated based on the second resource allocation. Therefore, when the interference is large, the access point device may instruct the station device to use the first resource allocation. When the access point device has low detection performance, the access point device may instruct the station device to use the second resource allocation, thereby reducing the detection complexity of the access point device.

Optionally, the plurality of resource allocations may include a plurality of resource allocations for each of a plurality of bandwidths. Optionally, the plurality of bandwidths comprise 20 MHz, 40 MHz, 80 MHz, 160 MHz, or 320 MHz.

Optionally, the plurality of resource allocations may be used for feedback of pre-emption requests when low-latency data transmission is required.

For example, the access point device may allocate a subcarrier set configuration for the station device to feed back the pre-emption request when low-latency data transmission is required.

Table 4 shows an allocation scheme of subcarrier sets for a 20 MHz bandwidth channel when N is 34. Seven subcarriers are allocated in each subcarrier set for a group of station devices corresponding to the subcarrier set to feed back pre-emption requests when LL data transmission is required. When the station device has no LL data transmission, it may not feed back the pre-emption request.

TABLE 4

| | Subcarrier numbers used in long | |
|---|---|---|
| | training field of first frame | |
| RU_SET | With low-latency data | Without low-latency data |
| 1 | −122, −88, −54, −20, 21, 55, 89 | Do not send NDP |
| 2 | −121, −87, −53, −19, 22, 56, 90 | |
| . . . | . . . | |
| 34 | −89, −55, −21, 20, 54, 88, 122 | |

In some embodiments, the second frame may include a user information field, and the resource allocation allocated by the access point device for at least one station device to feed back the pre-emption request may be indicated by the user information field. For example, the user information field includes a resource allocation field (or referred to as RU_SET allocation (RU_SET Allocation) field), where the RU_SET allocation field may be used to indicate the resource allocation, that is, the first indication information may be carried in the RU_SET allocation field.

Optionally, the length of the RU_SET allocation field may be determined based on the total quantity of candidate resource allocations. For example, if there are 32 resource allocation schemes, the RU_SET allocation field may be 5 bits; or, if there are 16 resource allocation schemes, the RU_SET allocation field may be 4 bits.

Optionally, the reserved field in the user information field may be redefined as the RU_SET allocation field. Taking the RU_SET allocation field occupying 5 bits as an example, the reserved bits from B12 to B16 in the user information field may be used as the RU_SET allocation field, but this application is not limited thereto. Taking the RU_SET allocation field occupying 4 bits as an example, the reserved bits from B12 to B15 in the user information field may be used as the RU_SET allocation field, but this application is not limited thereto.

Optionally, the user information field further includes a starting identification (starting_AID) field, which is used to indicate identification information of a starting station device polled by the second frame.

FIG. 10 is a schematic structural diagram of a user information field of a second frame according to an embodiment of this application. It should be noted that fields included in the user information field and positions and lengths of the fields are only examples, but this application is not limited thereto. They may be flexibly adjusted based on actual needs. For example, the user information field may include fewer or more fields.

Table 5 shows an example of values of the RU_SET allocation field and corresponding resource allocations according to an embodiment of this application.

TABLE 5

| | Total | | | |
|---|---|---|---|---|
| | quantity of | | Root for | |
| RU-SET | subcarrier | Sequence | generating | Subcarrier numbers contained |
| allocation | sets | length | a sequence | in subcarrier set |
| 1 | 34 | 7 | 1 | RU_SET 1 = {−122, −88, −54, −20, 21, 55, 89} |
| | | | | RU_SET 2 = {−121, −87, −53, −19, 22, 56, 90} |
| | | | | RU_SET 34 = {−89, −55, −21, 20, 54, 88, 122} |
| 2 | 14 | 17 | 1 | RU_SET 1 = {−122, −108, −94, −80, −66, −52, −38, −24, −10, . . . } |
| | | | | RU_SET 2 = {−121, −107, −93, −79, −65, −51, −37, −23, −9, . . . } |
| | | | | RU_SET 14 = {−109, −95, −81, −67, −53, −39, −25, . . . } |
| . . . | . . . | . . . | . . . | . . . |

Each value of the RU_SET allocation field may correspond to one resource allocation. Different values of the RU_SET allocation field may correspond to different resource allocations, for example, different subcarrier set grouping schemes, different sequence lengths, and different roots. It should be understood that the resource allocation schemes in Table 4 are only examples. In practice use, there may be more resource allocation schemes, or other resource allocation schemes may be used, and this application is not limited thereto.

In some embodiments, the access point device may select a target resource allocation from a plurality of resource allocations based on its own processing capability and/or channel conditions, and indicate the target resource allocation by setting the RU_SET allocation field in the second frame to the corresponding value. The station device may learn the resource allocation allocated by the access point device to the station device based on the value of the RU_SET allocation field in the second frame, and then determine the subcarrier set corresponding to the station device, the subcarriers in the subcarrier set, the sequence length, and the root based on the identification information of the station device.

In some embodiments, the second frame includes a feedback type (feedback type) field, the feedback type field being used to indicate a feedback type or response type of the second frame, that is, the meaning of the response or feedback frame (first frame) of the second frame. Optionally, when the value of the feedback type field is a second value, it indicates that the response or feedback frame of the second frame is a pre-emption request frame, or indicates that the station device responding to the second frame has a pre-emption request.

Optionally, the second value may be 0 or another value, which is not limited in this application.

Table 6 shows a relationship between values of the feedback type field and their corresponding meanings.

TABLE 6

| Value | Meaning (description information) |
|---|---|
| 0 | Pre-emption request |
| 1-15 | Reserved |

Optionally, as shown in FIG. 5, the feedback type field may be carried in the user information field of the second frame or another field of the second frame, which is not limited in this application.

Specific embodiments are used to describe specific implementations of how the station device determines the subcarrier set used to send the long training field and the sequence used in the long training field, and specific implementations of how the access point device determines the identification information of the station device based on the subcarrier set used to send the long training field and the sequence used in the long training field.

In some embodiments, the subcarrier set used by the station device to send the long training field being determined based on the identification information of the station device may include the following: the subcarrier set used by the station device to send the long training field is determined based on the identification information of the station device, in combination with a first mapping relationship, where the first mapping relationship is a mapping relationship between the identification information of the station device and the subcarrier set.

In some implementations, the first mapping relationship may be represented by the following formula (1), that is, index information of the subcarrier set used by the station device to send the long training field and the identification information of the station device satisfy the following formula (1):

$$RU\_SET \_INDEX = ( AID - starting\_AID ) mod N , \qquad Formula ( 1 )$$

where RU_SET_INDEX represents index information of the subcarrier set, AID represents the identification information of the station device, starting_AID represents identification information of a starting station device for which the access point device inquires the pre-emption request, N represents a total quantity of subcarrier sets, and mod represents modulo, where starting_AID and N may be indicated by the second frame.

In some embodiments, the sequence used in the long training field of the first frame sent by the station device being determined based on the identification information of the station device includes:
shift information of the sequence is determined based on the identification information of the station device; and/or
a root for generating a sequence is determined based on the identification information of the station device.

In some embodiments, the shift information of the sequence being determined based on the identification information of the station device may include:
the shift information of the sequence is determined based on the identification information of the station device and a second mapping relationship, where the second mapping relationship is a mapping relationship between the identification information of the station device and the shift information of the sequence.

In some implementations, the second mapping relationship may be represented by the following formula (2), that is, the shift information of the sequence and the identification information of the station device satisfy the following formula (2):

$$x = ⌊ \frac{AID - starting\_AID}{N} ⌋ , \qquad Formula ( 2 )$$

where x represents the shift information of the sequence, AID represents the identification information of the station device, starting_AID represents identification information of a starting station device for which the access point device inquires the pre-emption request, N represents a total quantity of subcarrier sets, and └ ┘ represents floor operation, where optionally, the floor operation may alternatively be replaced by other rounding manners, such as ceiling operation or rounding, and starting_AID and N may be indicated by the second frame.

In a specific embodiment, the first sequence being determined based on the identification information of the first station device includes:
shift information of the first sequence is determined based on the identification information of the first station device; and/or
a root for the first sequence is determined based on the identification information of the first station device.

In some specific embodiments, the first sequence is obtained by shifting a basic sequence based on first shift information, where the basic sequence is generated based on a root, and the first shift information is determined based on the identification information of the first station device.

Optionally, a plurality of station devices using the same subcarrier set may use the same root to generate the basic sequence, shift the basic sequence by using the shift information determined based on the identification information to obtain the shifted sequence, and then use the shifted sequence to fill the subcarrier set to obtain the long training field, so that the access point device may distinguish the station devices using one subcarrier set by the shift information.

In some embodiments, the sequence in the embodiments of this application may be an orthogonal sequence such as a ZC sequence, a pseudo-noise (PN) sequence, or the like, which is not limited in this application.

The ZC sequence has a series of characteristics, such as constant envelope, correlation, and orthogonality between ZC sequences. In this way, the mutual orthogonality may still be ensured when a plurality of station devices using the same subcarrier set fill the long training field with different ZC sequences, reducing interference between signals. In addition, since the ZC sequence has good correlation, the correlation result between the cyclically shifted ZC sequence and the original sequence is 0, which facilitates the receiver to recover the ZC sequence (that is, access point device), and further to identify the station device based on the recovered ZC sequence.

In the embodiments of this application, the station device may use one of the N subcarrier sets to send the long training field, that is, the sequence of the long training field only occupies one subcarrier set among the N subcarrier sets. It may be considered that this application adopts a manner of sending a short sequence (such as short ZC sequence) within the subcarrier set. Compared with directly sending a long ZC sequence in the entire frequency domain, using the manner of sending a short ZC sequence within the subcarrier set helps to reduce the complexity of detecting the ZC sequence by the receiver (that is, access point device). In this way, when the probability of station devices in a basic service set (BSS) sending pre-emption requests is low, the access point device only needs to perform sequence detection on several subcarrier sets with signals, which may further reduce the computational complexity and lower the hardware performance requirements for the access point device.

In some embodiments of this application, the method 200 further includes: the access point device may perform energy detection on the long training field of the first frame to determine the subcarrier set used in the long training field, for example, if energy or signal exists on the first subcarrier set among the N subcarrier sets, the subcarrier set used in the long training field is determined as the first subcarrier set.

In some embodiments of this application, the method 200 further includes:
the access point device may perform sequence detection on the long training field of the first frame to determine the sequence used in the long training field, for example, the shift information of the sequence.

It should be understood that the specific implementation of performing sequence detection on the long training field of the first frame to determine the shift information of the sequence is not limited in this application. For example, the access point device determines the shift information of the detected sequence by comparing the basic sequence and the detected sequence. For another example, the correlation between a plurality of sequences with different shift information and the detected sequence is calculated, and the shift information of the sequence with the highest correlation is used as the shift information of the sequence of the long training field.

In some embodiments of this application, S220 includes:
the access point device determines the identification information of the first station device based on the subcarrier set used in the long training field of the first frame and the shift information of the sequence used in the long training field.

For example, the access point device determines the identification information of the first station device based on the subcarrier set used in the long training field of the first frame and the shift information of the sequence used in the long training field, in combination with related configurations (for example, starting_AID and resource allocation (such as the quantity of subcarrier sets)) for feeding back the first status in the second frame.

In some implementations, the determining the identification information of the first station device based on the subcarrier set used in the long training field of the first frame and the shift information of the sequence used in the long training field includes:
the access point device may determine the identification information of the first station device based on the subcarrier set used in the long training field and the shift information of the sequence used in the long training field, in combination with a first mapping relationship and a second mapping relationship, where the first mapping relationship is a mapping relationship between identification information of a station device and a subcarrier set, and the second mapping relationship is a mapping relationship between the identification information of the station device and shift information of a sequence.

For example, after obtaining the subcarrier set used in the long training field and the shift information of the sequence used in the long training field, the access point device may further determine the identification information of the first station device in combination with the relationship between the subcarrier set and shift information and the identification information of the station device, for example, the identification information of the station device is determined based on the subcarrier set and the shift information in combination with the first mapping relationship (for example, formula (1)) and the second mapping relationship (for example, formula (2)).

In an embodiment, the access point device determines the identification information of the first station device based on the subcarrier set used in the long training field of the first frame sent by the first station device and the shift information of the sequence used in the long training field, in combination with the following formula (3), that is, the subcarrier set used in the long training field of the first frame sent by the station device, the shift information of the sequence used in the long training field, and the identification information of the station device satisfy the following formula (3):

$$AID = starting\_AID + RU\_SET \_INDEX \times N + x , \qquad Formula ( 3 )$$

where RU_SET_INDEX represents index information of the subcarrier set, AID represents the identification information of the station device, N represents the quantity of subcarrier sets, and x represents the shift information of the sequence.

In conclusion, in the polling mechanism provided in the embodiments of this application, the access point device may identify the identification information of the station device based on the subcarrier set used in the long training field of the first frame sent by the station device and the sequence used in the long training field, thereby learning that the station device corresponding to the identification information needs to feed back the first status. In this way, the quantity of station devices that may be inquired in one polling is related to the total quantity of subcarrier sets and the total quantity of sequences. Therefore, based on the polling solution in the embodiments of this application, the quantity of station devices that may provide feedback in one polling is expanded, improving the polling efficiency.

The embodiments of this application further design a resource allocation scheme in the polling mechanism. For example, a plurality of optional resource allocation schemes are designed according to anti-interference capability of signals and/or computational complexity of detection on an AP side, for use by the AP side under different interference conditions and/or detection performance conditions.

The embodiments of this application further design a mapping method between identification information of station devices and subcarrier sets and shift information of sequences in the polling mechanism. The mapping method can ensure that a plurality of station devices may be evenly allocated to different subcarrier sets, and a group of station devices may use appropriate shift information to ensure the orthogonality of sequences used by station devices using the same subcarrier set, thereby reducing interference between signals.

The embodiments of this application further provide a frame structure design for the polling frame in the polling mechanism. The frame structure can ensure that the receiver (that is, station device) of the polling frame learns that the polling frame is used to inquire whether status feedback is required, and learns the resource information allocated by the access point device to the station device for status feedback, such as subcarrier information and sequence information.

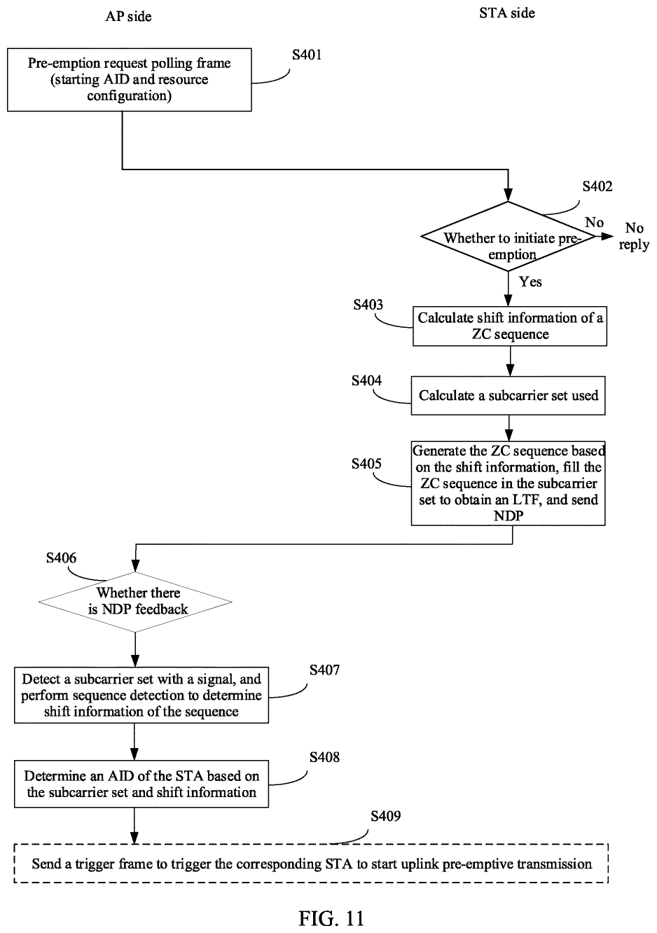

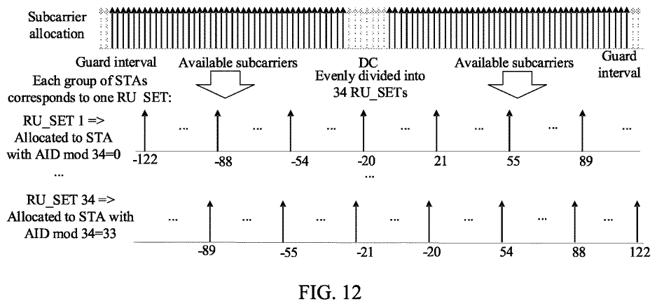

The following, with reference to FIG. 11, describes the overall process of the status feedback method provided in the embodiments of this application using an example where the first status is a pre-emption request, the first frame is an NDP frame, the second frame is a pre-emption request polling frame, the identification information of the station device is an AID, and the sequence is a ZC sequence.

As shown in FIG. 11, the method may include at least part of the following steps.

S401. An AP sends a pre-emption request polling frame.

The trigger type field of the pre-emption request polling frame indicates a first value (for example, 8), indicating that the frame is used to inquire whether an STA has a pre-emption request.

The feedback type field of the pre-emption request polling frame indicates a second value (for example, 0), indicating that a response frame of the frame is used to feed back that there is a pre-emption request.

The pre-emption request polling frame may indicate starting identification information and a resource allocation, where the starting identification information is used to indicate a starting AID of this polling by the AP, and the resource allocation is used to indicate a subcarrier configuration (for example, the quantity of subcarrier sets or subcarrier numbers contained in the subcarrier set) and sequence configuration (for example, sequence length L or root) allocated by the AP for the STA to feed back the pre-emption request.

The TA field in the pre-emption request polling frame may be set to the AID of the AP, and the RA field may be set to a broadcast address (broadcast address), indicating that all STAs receive and demodulate this frame.

S402. After receiving the pre-emption request polling frame, the STA determines whether itself has a pre-emption demand or whether to initiate pre-emption. If there is no pre-emption demand, the station device may not respond and discard the pre-emption request polling frame. Alternatively, if the STA has a pre-emption demand, it may perform the following steps S403 to S405.

Optionally, when low-latency data arrives, the STA may determine that there is a pre-emption demand, and then determine to respond with an NDP frame.

Optionally, when no low-latency data arrives, the STA may determine that there is no pre-emption demand, and does not respond with an NDP frame.

S403. The STA calculates shift information of the ZC sequence based on its own AID and the starting identification information (that is, starting_AID) and resource allocation (for example, the quantity of subcarrier sets) indicated in the pre-emption request polling frame.

For example, the STA determines shift information x of the ZC sequence based on its own AID and the starting identification information (that is, starting_AID) and resource allocation (for example, the quantity of subcarrier sets) indicated in the pre-emption request polling frame, in combination with formula (2).

S404. The STA calculates index information of a subcarrier set used to send a long training field based on its own AID and the starting identification information (that is, starting_AID) and resource allocation (for example, the quantity of subcarrier sets) indicated in the pre-emption request polling frame.

For example, the STA determines the index information of the subcarrier set used to send the long training field based on its own AID and the starting identification information (that is, starting_AID) and resource allocation (for example, the quantity of subcarrier sets) indicated in the pre-emption request polling frame, in combination with formula (1). The subcarrier set includes L subcarriers.

It should be understood that the STA may alternatively perform S404 before performing S403, or perform the two steps simultaneously, which is not limited in this application.

S405. The STA generates a basic sequence (also referred to as original sequence) with a sequence length L, cyclically shifts the original sequence by x to obtain a first sequence, uses the first sequence to fill the subcarrier set obtained in S404 to obtain a long training field of the NDP frame, one sequence symbol of the first sequence being filled in each subcarrier in the subcarrier set, and sends the NDP frame.

S406. The AP detects whether there is an STA responding with an NDP frame. If no NDP frame is received, it is determined that no STA has a pre-emption request.

S407. The subcarrier set with a signal is detected, and sequence detection is performed on the subcarrier set with a signal to determine shift information of the sequence.

For example, if an NDP frame is received, the AP may determine the subcarrier set used in the long training field of the NDP frame through energy detection on the NDP frame (for example, detecting which subcarrier sets have signals), and then perform sequence detection through the signal received on the subcarrier set to identify the shift information x of the ZC sequence. For example, correlation detection is performed between a plurality of sequences with different shifts and the received signal, and the shift corresponding to the sequence with the highest correlation is used as the shift information of the sequence used in the long training field.

S408. The AID of the STA is determined based on the subcarrier set used in the long training field and the shift information of the sequence used in the long training field.

For example, after obtaining the subcarrier set and the shift information of the ZC sequence, the AP may determine the AID of the STA in combination with formula (3), and thus learns AIDs of STAs that have pre-emption requests.

S409. The AP may send a trigger frame to trigger the STA with a pre-emption request to start uplink pre-emptive transmission.

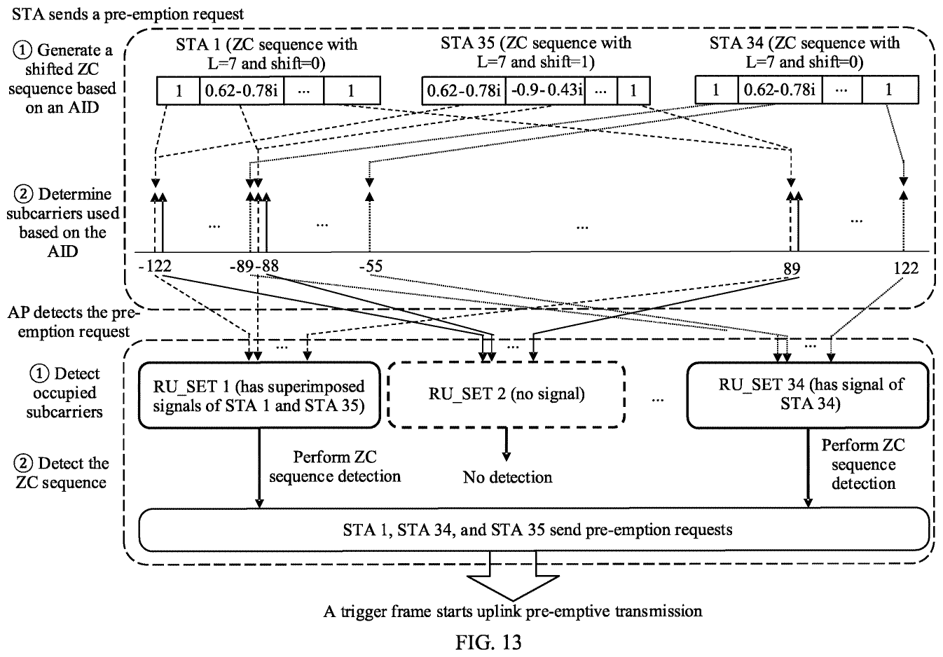

The following, with reference to FIGS. 12 and 13, describes the specific implementation of symbol filling on the STA side and pre-emption request detection on the AP side using an example of 20 MHz bandwidth and N being 34.

As shown in FIG. 12, when Nis 34, a group of STAs with AID modulo 34 equal to 0 is allocated to RU_SET 1, including subcarriers {−122, −88, −54, −20, 21, 55, 89}, a group of STAs with AID modulo 34 equal to 1 is allocated to RU_SET 2, including subcarriers {−121, −87, −53, −19, 22, 56, 90}, . . . , and a group of STAs with AID modulo 34 equal to 33 is allocated to RU_SET 34, including subcarriers {−89, −55, −21, 20, 54, 88, 122}. Each subcarrier set includes seven subcarriers, which may carry a ZC sequence of length 7, meaning that there may be at most seven groups of orthogonal ZC sequences. Therefore, each subcarrier set may be allocated to at most seven STAs, so that a group of STAs corresponding to the same subcarrier set may be distinguished by orthogonal ZC sequences.

Further, the STA may generate an original ZC sequence based on the sequence length (for example, L=7) and root (for example, 1). For example, the original ZC sequence is {1, 0.62−0.78i, −0.9−0.43i, 0.62+0.78i, −0.9−0.43i, 0.62−0.78i, 1}.

Then, the STA calculates shift information x based on the AID of the STA in combination with formula (2), shifts the original ZC sequence by x to obtain the shifted ZC sequence, and uses the shifted ZC sequence to fill the corresponding subcarrier set.

Taking RU_SET 1 as an example, the shifted ZC sequences determined by a group of STAs corresponding to RU_SET 1 are shown in Table 7.

TABLE 7

| STA | Filling sequence |
|---|---|
| STA 1 (x = 0) | 1, 0.62 − 0.78i, −0.9 − 0.43i, 0.62 + 0.78i, −0.9 − 0.43i, 0.62 − 0.78i, 1 |
| STA 2 (x = 1) | 0.62 − 0.78i, −0.9 − 0.43i, 0.62 + 0.78i, −0.9 − 0.43i, 0.62 − 0.78i, 1, 1 |
| . . . | . . . |
| STA 239 (x = 6) | 1, 1, 0.62 − 0.78i, −0.9 − 0.43i, 0.62 + 0.78i, −0.9 − 0.43i, 0.62 − 0.78, |

Due to the good correlation of the ZC sequence, the correlation result between the cyclically shifted ZC sequence and the original sequence is 0, that is, the AP may recover them separately upon reception without mutual interference, and further identify the STA based on the recovered ZC sequence.

FIG. 13 is a schematic diagram of an STA side sending a pre-emption request and an AP side detecting the pre-emption request in a 20 MHz bandwidth when N is 34. In this example, it is assumed that STA 1, STA 34, and STA 35 have pre-emption requests.

### STA Side:

Step 1: The STA generates a shifted ZC sequence based on an AID.

For example, STA 1 determines that the shift information of the sequence is 0 based on the AID, and generates a ZC sequence with shift 0; STA 34 determines that the shift information of the sequence is 0 based on the AID, and generates a ZC sequence with shift 0; and STA 35 determines that the shift information of the sequence is 1 based on the AID, and generates a ZC sequence with shift 1.

Step 2: The STA selects RU_SET based on the AID.

For example, STA 1 and STA 35 both select RU_SET 1 based on the AID, and STA 34 selects RU_SET 34 based on the AID.

Then, the STA sends an NDP frame in the subcarrier set corresponding to RU_SET, where the long training field of the NDP frame is filled using the shifted ZC sequence.

AP side:

Step 3: Detect subcarriers occupied by the long training field.

The AP side receives the long training field of the NDP frame, and may determine which subcarrier sets have signals through energy detection on the NDP. For example, in this example, the AP detects signal transmission in RU_SET 1 and RU_SET 34.

Step 4: Perform sequence detection.

The AP performs ZC sequence detection on RU_SET 1 and RU_SET 34 with signal transmission, for example, correlating different shifted ZC sequences with the received signal separately to detect whether the signal includes components of the shifted ZC sequence, thereby determining which shifted ZC sequence is included in the signal, and obtaining the shift information of the ZC sequence in RU_SET 1 and RU_SET 34.

After obtaining RU_SET occupied by the long training field and the shift information of the ZC sequence filling the long training field, the AP may recover the AIDs (for example, determining the AID of the STA according to formula (3)) of STA 1, STA 34, and STA 35, thereby determining that STA 1, STA 34, and STA 35 have sent pre-emption requests, and further starting uplink pre-emptive transmission through a trigger frame.

Therefore, the pre-emption request inquiry mechanism provided in the embodiments of this application increases the quantity of STAs covered by a single polling, and reduces the time consumed during “pre-emption request inquiry” in the pre-emption process, so that when the pre-emption request inquiry mechanism is applied to the low-latency pre-emption mechanism, the time for pre-emption request reporting is greatly shortened, effectively reducing the waiting delay of low-latency data and reducing the impact on the pre-empted data transmission, thereby improving the efficiency of the pre-emption process.

In addition, the embodiments of this application use a manner of sending a short ZC sequence within the subcarrier set. Compared with directly sending a long ZC sequence in the entire frequency domain, this manner helps to reduce the complexity of detecting the ZC sequence by the receiver (that is, AP side). When the probability of STAs in the BSS sending pre-emption requests is low, the AP only needs to perform sequence detection on several subcarrier sets with signals, which may further reduce the computational complexity and lower the hardware performance requirements for the AP.

Moreover, the embodiments of this application provide a plurality of groups of resource allocation schemes in terms of sequence length and subcarrier allocation, which may meet the needs of pre-emption request polling under different channel conditions and different AP side processing capability conditions, and have strong flexibility and adaptability to environmental changes.

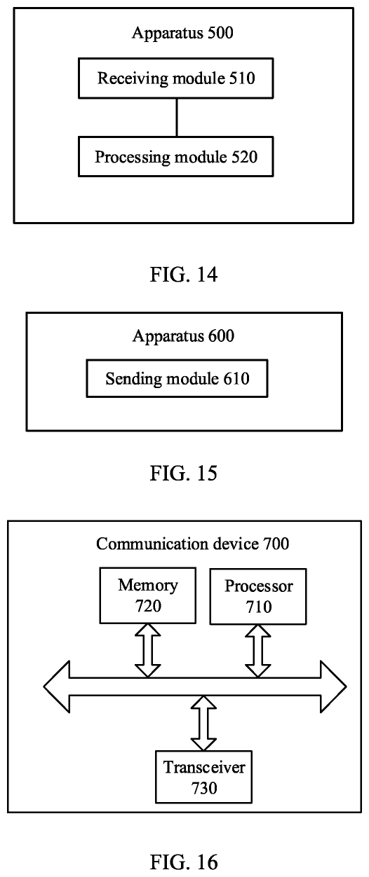

The method embodiments of this application are described in detail above with reference to FIGS. 9 to 13. The following describes the apparatus embodiments of this application in detail with reference to FIGS. 14 to 18. It should be understood that the apparatus embodiments correspond to the method embodiments, and similar descriptions may refer to the method embodiments.

FIG. 14 is a schematic block diagram of a wireless communication apparatus 500 according to an embodiment of this application. The wireless communication apparatus 500 may be an access point device or a component in an access point device, such as a chip, a circuit, or a module.

As shown in FIG. 14, the wireless communication apparatus 500 includes:
a receiving module 510, configured to receive a first frame sent by a first station device, the first frame being used to feed back a first status to an access point device; and
a processing module 520, configured to determine identification information of the first station device based on a subcarrier set used in a long training field of the first frame and a sequence used in the long training field.

In some embodiments, the apparatus 500 further includes:
a sending module, configured to send a second frame to at least one station device, the second frame being used to inquire whether the at least one station device needs to feed back the first status, and the at least one station device including the first station device; where
the second frame includes first indication information, the first indication information being used to indicate a resource allocation allocated by the access point device for the at least one station device to feed back the first status, and the resource allocation including a subcarrier configuration and a sequence configuration.

In some embodiments, the resource allocation includes at least one of the following:
a total quantity of subcarrier sets, a subcarrier number contained in each subcarrier set, a sequence length, and a root for generating a sequence.

In some embodiments, the second frame includes a user information field, the user information field includes a resource allocation field, and the first indication information is carried in the resource allocation field.

In some embodiments, the first indication information is a first resource allocation index, the first resource allocation index is one of a plurality of resource allocation indices, and each of the plurality of resource allocation indices corresponds to one resource allocation.

In some embodiments, the second frame includes a trigger type field, the trigger type field being used to indicate that the second frame is used to inquire whether the station device needs to feed back the first status.

In some embodiments, the second frame includes a feedback type field, the feedback type field being used to indicate a feedback type of the second frame, and the feedback type being feedback of the first status.

In some embodiments, the processing module 520 is further configured to:
perform sequence detection on the long training field of the first frame to determine shift information of the sequence used in the long training field of the first frame; and
determine the identification information of the first station device based on the subcarrier set used in the long training field of the first frame and the shift information of the sequence used in the long training field.

In some embodiments, the processing module 520 is further configured to:
determine the identification information of the first station device based on the subcarrier set used in the long training field and the shift information of the sequence used in the long training field, in combination with a first mapping relationship and a second mapping relationship, where the first mapping relationship is a mapping relationship between identification information of a station device and a subcarrier set, and the second mapping relationship is a mapping relationship between the identification information of the station device and shift information of a sequence.

In some embodiments, the second mapping relationship is represented by the following formula:

$$x = ⌊ \frac{AID - starting\_AID}{N} ⌋ ,$$

where x represents the shift information of the sequence of the long training field, AID represents the identification information of the station device, starting_AID represents identification information of a starting station device for which the access point device inquires whether to feed back the first status, and N represents a total quantity of subcarrier sets allocated by the access point device for the at least one station device to feed back the first status.

In some embodiments, the first mapping relationship is represented by the following formula:

$$RU\_SET \_INDEX = ( AID - starting\_AID ) mod N ,$$

where RU_SET_INDEX represents index information of the subcarrier set, AID represents the identification information of the station device, starting_AID represents identification information of a starting station device for which the access point device inquires whether to feed back the first status, and N represents a total quantity of subcarrier sets allocated by the access point device for the at least one station device to feed back the first status.

In some embodiments, the processing module 520 is further configured to:
determine the identification information of the first station device based on the subcarrier set used in the long training field and the shift information of the sequence used in the long training field, in combination with the following formula:

$$AID = starting\_AID + RU\_SET \_INDEX \times N + x ,$$

where AID represents the identification information of the station device, starting_AID represents identification information of a starting station device for which the access point device inquires whether to feed back the first status, RU_SET_INDEX represents index information of the subcarrier set, N represents a total quantity of subcarrier sets allocated by the access point device for the at least one station device to feed back the first status, and x represents the shift information of the sequence of the long training field.

In some embodiments, the first status indicates that a station device has a pre-emptive transmission requirement or a low-latency data transmission requirement.

In some embodiments, the first status includes a pre-emption request or a low-latency data transmission request.

Optionally, in some embodiments, the foregoing sending module or receiving module may be a communication interface, a transceiver, a communication chip, or an input/output interface of a system-on-chip. The foregoing processing module may be one or more processors.

It should be understood that the wireless communication apparatus 500 according to the embodiments of this application corresponds to the access point device in the method embodiments of this application, and the foregoing and other operations and/or functions of the units in the wireless communication apparatus 500 are for implementing the corresponding processes of the access point device in the embodiments shown in FIGS. 9 to 13, which are not described herein again for brevity.

FIG. 15 is a schematic block diagram of another wireless communication apparatus 600 according to an embodiment of this application. The wireless communication apparatus 600 may be a station device or a component in a station device, such as a chip, a circuit, or a module. The wireless communication apparatus 600 in FIG. 15 includes:
a sending module 610, configured to send a first frame to an access point device, the first frame being used to feed back a first status to the access point device; where
a long training field of the first frame is transmitted using a first subcarrier set among N subcarrier sets, where the first subcarrier set is determined based on identification information of a station device, and N is a positive integer greater than 1; where
the long training field is obtained by filling based on a first sequence, the first sequence being determined based on the identification information of the station device.

In some embodiments, the apparatus 600 further includes:
a receiving module, configured to receive a second frame sent by the access point device, the second frame being used to inquire whether at least one station device needs to feed back the first status; where
the second frame includes first indication information, the first indication information being used to indicate a resource allocation allocated by the access point device for the at least one station device to feed back the first status, and the resource allocation including a subcarrier configuration and a sequence configuration.

In some embodiments, the resource allocation includes at least one of the following:
a total quantity of subcarrier sets, a subcarrier number contained in each subcarrier set, a sequence length, and a root for generating a sequence.

In some embodiments, the first indication information is a first resource allocation index, the first resource allocation index is one of a plurality of resource allocation indices, and each of the plurality of resource allocation indices corresponds to one resource allocation.

In some embodiments, the second frame includes a user information field, the user information field includes a resource allocation field, and the first indication information is carried in the resource allocation field.

In some embodiments, the second frame includes a trigger type field, the trigger type field being used to indicate that the second frame is used to inquire whether the station device needs to feed back the first status.

In some embodiments, the second frame includes a feedback type field, the feedback type field being used to indicate a feedback type of the second frame, and the feedback type being feedback of the first status.

In some embodiments, the first sequence being determined based on the identification information of the station device includes:
the first sequence is obtained by shifting a basic sequence based on first shift information, where the first shift information is determined based on the identification information of the station device, and the basic sequence is generated based on a root for generating a sequence.

In some embodiments, the first shift information and the identification information of the station device satisfy a second mapping relationship, the second mapping relationship being represented by the following formula:

$$x = ⌊ \frac{AID - starting\_AID}{N} ⌋ ,$$

where x represents the first shift information, AID represents the identification information of the station device, starting_AID represents identification information of a starting station device for which the access point device inquires whether to feed back the first status, and N represents a total quantity of subcarrier sets.

In some embodiments, index information of the first subcarrier set and the identification information of the station device satisfy a first mapping relationship, the first mapping relationship being represented by the following formula:

$$RU\_SET \_INDEX = ( AID - starting\_AID ) mod N ,$$

where RU_SET_INDEX represents the index information of the first subcarrier set, AID represents the identification information of the station device, starting_AID represents identification information of a starting station device for which the access point device inquires whether to feed back the first status, and N represents a total quantity of subcarrier sets.

In some embodiments, the first status includes a pre-emption request or a low-latency data transmission request.

In some embodiments, the first status is used to feed back to the access point device that the station device has a pre-emptive transmission requirement or a low-latency data transmission requirement.

Optionally, in some embodiments, the foregoing sending module or receiving module may be a communication interface, a transceiver, a communication chip, or an input/output interface of a system-on-chip.

It should be understood that the wireless communication apparatus 600 according to the embodiments of this application corresponds to the station device in the method embodiments of this application, and the foregoing and other operations and/or functions of the units in the wireless communication apparatus 600 are for implementing the corresponding processes of the station device in the method embodiments shown in FIGS. 9 to 13, which are not described herein again for brevity.

FIG. 16 is a schematic structural diagram of a communication device 700 according to an embodiment of this application. The communication device 700 shown in FIG. 16 includes a processor 710. The processor 710 may invoke and run a computer program from a memory to implement the method in the embodiments of this application.

Optionally, as shown in FIG. 16, the communication device 700 may further include a memory 720. The processor 710 may invoke and run a computer program from the memory 720 to implement the method in the embodiments of this application. For example, when the communication device 700 is a station device, the processor 710 may invoke and run a computer program from the memory 720 to implement steps of the method embodiments executed by the station device, with the same technical effects achieved. When the communication device 700 is an access point device, the processor 710 may invoke and run a computer program from the memory 720 to implement steps of the method embodiments executed by the access point device, with the same technical effects achieved.

Optionally, the memory 720 may be a separate device independent of the processor 710, or integrated in the processor 710.

Optionally, as shown in FIG. 16, the communication device 700 may further include a transceiver 730. The processor 710 may control the transceiver 730 to communicate with other devices, and specifically, send information or data to other devices, or receive information or data sent by other devices.

Optionally, the transceiver 730 may include a transmitter and a receiver. The transceiver 730 may further include an antenna, and the quantity of antennas may be one or more.

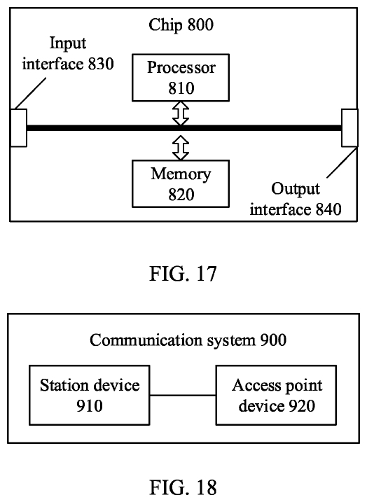

FIG. 17 is a schematic structural diagram of a chip according to an embodiment of this application. The chip 800 shown in FIG. 17 includes a processor 810. The processor 810 may invoke and run a computer program from a memory to implement the method in the embodiments of this application.

Optionally, as shown in FIG. 17, the chip 800 may further include a memory 820. The processor 810 may invoke and run a computer program from the memory 820 to implement the method in the embodiments of this application.

Optionally, the memory 820 may be a separate device independent of the processor 810, or integrated in the processor 810.

Optionally, the chip 800 may further include an input interface 830. The processor 810 may control the input interface 830 to communicate with other devices or chips, for example, obtain information or data sent by other devices or chips.

Optionally, the chip 800 may further include an output interface 840. The processor 810 may control the output interface 840 to communicate with other devices or chips, for example, output information or data to other devices or chips.

Optionally, the chip may be applied to the access point device in the embodiments of this application, and the chip may implement the corresponding processes implemented by the access point device in the methods of the embodiments of this application, which are not described herein again for brevity.

Optionally, the chip may be applied to the station device in the embodiments of this application, and the chip may implement the corresponding processes implemented by the station device in the methods of the embodiments of this application, which are not described herein again for brevity.

It should be understood that the chip mentioned in the embodiments of this application may also be referred to as a system-level chip, a system chip, a chip system, a system-on-chip, or the like.

FIG. 18 is a schematic block diagram of a communication system 900 according to an embodiment of this application. As shown in FIG. 18, the communication system 900 includes a station device 910 and an access point device 920.

The station device 910 may be used to implement the corresponding functions implemented by the station device in the foregoing method, and the access point device 920 may be used to implement the corresponding functions implemented by the access point device in the foregoing method, which are not described herein again for brevity.

It should be understood that the processor in the embodiments of this application may be an integrated circuit chip with a signal processing capability. During implementation, the steps of the foregoing method embodiments may be implemented by hardware integrated logic circuits in the processor or instructions in the form of software. The processor may be a general-purpose processor, a digital signal processor (DSP), an application specific integrated circuit (ASIC), a field programmable gate array (FPGA) or another programmable logic device, a discrete gate or transistor logic device, or a discrete hardware component. The processor may implement or execute the methods, steps, and logical block diagrams disclosed in the embodiments of this application. The general-purpose processor may be a microprocessor or any regular processor. The steps of the methods disclosed with reference to the embodiments of the application may be directly implemented by a hardware decoding processor, or may be implemented by a combination of hardware and a software module in a decoding processor. The software module may be located in a storage medium mature in the art, such as a random access memory, a flash memory, a read-only memory, a programmable read-only memory or electrically erasable programmable memory, or a register. The storage medium is located in the memory, and the processor fetches information in the memory, and completes the steps of the foregoing method in combination with its hardware.

It can be understood that the memory in this embodiment of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of example but not restrictive description, many forms of RAMs may be used, for example, a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). It should be noted that the memory in the system and method described in this specification is intended to comprise these and any other suitable types of memories.

It should be understood that the foregoing memories are examples but not restrictive description. For example, the memory in the embodiments of this application may alternatively be a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), or a direct rambus random access memory (DRRAM). That is, the memory in the embodiments of this application is intended to comprise these and any other applicable types of memories.

An embodiment of this application further provides a readable storage medium. The readable storage medium stores a computer program, and when the computer program is executed by a processor, the processes of the foregoing method embodiments are implemented.

Optionally, the readable storage medium may be applied to the access point device in the embodiments of this application, and the computer program causes the processor to execute the corresponding processes implemented by the access point device in the method embodiments of this application, which are not described herein again to avoid repetition.

Optionally, the readable storage medium may be applied to the station device in the embodiments of this application, and the computer program causes the processor to execute the corresponding processes implemented by the station device in the method embodiments of this application, which are not described herein again to avoid repetition.

An embodiment of this application further provides a computer program product, including a computer program. When the computer program is executed by a processor, the processes of the foregoing method embodiments are implemented.

Optionally, the computer program product may be applied to the access point device in the embodiments of this application, and the computer program causes the processor to execute the corresponding processes implemented by the access point device in the method embodiments of this application, which are not described herein again to avoid repetition.

Optionally, the computer program product may be applied to the station device in the embodiments of this application, and the computer program causes the processor to execute the corresponding processes implemented by the station device in the method embodiments of this application, which are not described herein again to avoid repetition.

An embodiment of this application further provides a computer program. When the computer program is executed by a processor, the processes of the foregoing method embodiments are implemented.

Optionally, the computer program may be applied to the access point device in the embodiments of this application, and the computer program causes the processor to execute the corresponding processes implemented by the access point device in the method embodiments of this application, which are not described herein again to avoid repetition.

Optionally, the computer program may be applied to the station device in the embodiments of this application, and the computer program causes the processor to execute the corresponding processes implemented by the station device in the method embodiments of this application, which are not described herein again to avoid repetition.

Persons of ordinary skill in the art may realize that the units and algorithm steps in the examples described with reference to the embodiments disclosed in this specification may be implemented by using electronic hardware or a combination of computer software and electronic hardware. Whether the functions are performed by hardware or software depends on particular applications and design constraints of the technical solutions. Persons skilled in the art may use different methods to implement the described functions for each particular application, but it should not be considered that the implementation goes beyond the scope of this application.

Persons skilled in the art may clearly understand that, for the purpose of convenient and brief description, for a detailed working process of the foregoing system, apparatus, and unit, reference may be made to a corresponding process in the foregoing method embodiments, and details are not described herein again.

In several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network elements. Some or all of these units may be selected based on actual needs to achieve the objectives of the solutions of the embodiments.

In addition, the functional units in the embodiments of this application may be integrated into one processing unit, or each of the units may exist alone physically, or two or more units may be integrated into one unit.

If the functions are implemented in a form of a software functional unit and are sold or used as a separate product, the functions may be stored in a computer-readable storage medium. Based on such understanding, the technical solutions of this application essentially, or the part thereof that contributes to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the method described in the embodiments of this application. The foregoing storage medium includes: any medium that may store program code, such as a USB flash drive, a removable hard disk, a read-only memory (ROM), a random access memory (RAM), a magnetic disk, or an optical disc.

The foregoing descriptions are only specific implementations of this application, but are not intended to limit the protection scope of this application. Any variation or replacement apparent to persons skilled in the art within the technical scope disclosed in this application shall fall within the protection scope of this application. Therefore, the protection scope of this application shall be subject to the protection scope of the claims.

What is claimed is:

1. A status feedback method, comprising:
receiving, by an access point device, a first frame sent by a first station device, the first frame being used to feed back a first status to the access point device; and
determining, by the access point device, identification information of the first station device based on a subcarrier set used in a long training field of the first frame and a sequence used in the long training field.

2. The method according to claim 1, wherein before the receiving, by the access point device, the first frame sent by the first station device, the method further comprises:
sending, by the access point device, a second frame to at least one station device, the second frame being used to inquire whether the at least one station device needs to feed back the first status, and the at least one station device comprising the first station device; wherein
the second frame comprises first indication information, the first indication information being used to indicate a resource allocation allocated by the access point device for the at least one station device to feed back the first status, and the resource allocation comprising a subcarrier configuration and a sequence configuration.

3. The method according to claim 2, wherein the resource allocation comprises at least one of the following:
a total quantity of subcarrier sets, a subcarrier number contained in each subcarrier set, a sequence length, and a root for generating a sequence.

4. The method according to claim 2, wherein the second frame comprises at least one of the followings:
a user information field, the user information field comprises a resource allocation field, and the first indication information is carried in the resource allocation field;
a trigger type field, the trigger type field being used to indicate that the second frame is used to inquire whether the at least one station device needs to feed back the first status; or
a feedback type field, the feedback type field being used to indicate a feedback type of the second frame, and the feedback type being feedback of the first status.

5. The method according to claim 2, wherein the first indication information is a first resource allocation index, the first resource allocation index is one of a plurality of resource allocation indices, and each of the plurality of resource allocation indices corresponds to one resource allocation.

6. The method according to claim 1, wherein the method further comprises:
performing sequence detection on the long training field of the first frame to determine shift information of the sequence used in the long training field of the first frame; wherein
the determining, by the access point device, the identification information of the first station device based on the subcarrier set used in the long training field of the first frame and the sequence used in the long training field comprises:
determining the identification information of the first station device based on the subcarrier set used in the long training field of the first frame and the shift information of the sequence used in the long training field.

7. The method according to claim 6, wherein the determining the identification information of the first station device based on the subcarrier set used in the long training field of the first frame and the shift information of the sequence used in the long training field comprises:
determining the identification information of the first station device based on the subcarrier set used in the long training field and the shift information of the sequence used in the long training field, in combination with a first mapping relationship and a second mapping relationship, wherein the first mapping relationship is a mapping relationship between identification information of a station device and a subcarrier set, and the second mapping relationship is a mapping relationship between the identification information of the station device and shift information of a sequence.

8. The method according to claim 7, wherein the second mapping relationship is represented by the following formula:
$$x = ⌊ \frac{AID - starting\_AID}{N} ⌋ ,$$
wherein x represents the shift information of the sequence of the long training field, AID represents the identification information of the station device, starting_AID represents identification information of a starting station device for which the access point device inquires whether to feed back the first status, and N represents a total quantity of subcarrier sets allocated by the access point device for the at least one station device to feed back the first status;
wherein the first mapping relationship is represented by the following formula:
$$RU\_SET \_INDEX = ( AID - starting\_AID ) mod N ,$$
wherein RU_SET_INDEX represents index information of the subcarrier set, AID represents the identification information of the station device, starting_AID represents identification information of a starting station device for which the access point device inquires whether to feed back the first status, and N represents a total quantity of subcarrier sets allocated by the access point device for the at least one station device to feed back the first status.

9. The method according to claim 7, wherein the determining the identification information of the first station device based on the subcarrier set used in the long training field and the shift information of the sequence used in the long training field, in combination with the first mapping relationship and the second mapping relationship comprises:
determining the identification information of the first station device based on the subcarrier set used in the long training field and the shift information of the sequence used in the long training field, in combination with the following formula:
$$AID = starting\_AID + RU\_SET \_INDEX \times N + x ,$$
wherein AID represents the identification information of the station device, starting_AID represents identification information of a starting station device for which the access point device inquires whether to feed back the first status, RU_SET_INDEX represents index information of the subcarrier set, N represents a total quantity of subcarrier sets allocated by the access point device for the at least one station device to feed back the first status, and x represents the shift information of the sequence of the long training field.

10. The method according to claim 1, wherein the first status indicates that a station device has a pre-emptive transmission requirement or a low-latency data transmission requirement.

11. A status feedback method, comprising:
sending, by a first station device, a first frame to an access point device, the first frame being used to feed back a first status to the access point device; wherein
a long training field of the first frame is transmitted using a first subcarrier set among N subcarrier sets, wherein the first subcarrier set is determined based on identification information of the first station device, and N is a positive integer greater than or equal to 1; wherein
the long training field is obtained by filling based on a first sequence, the first sequence being determined based on the identification information of the first station device.

12. The method according to claim 11, wherein before the sending, by the first station device, the first frame to the access point device, the method further comprises:
receiving, by the first station device, a second frame sent by the access point device, the second frame being used to inquire whether at least one station device needs to feed back the first status, wherein the at least one station device comprises the first station device; wherein
the second frame comprises first indication information, the first indication information being used to indicate a resource allocation allocated by the access point device for the at least one station device to feed back the first status, and the resource allocation comprising a subcarrier configuration and a sequence configuration.

13. The method according to claim 12, wherein the resource allocation comprises at least one of the following:
a total quantity of subcarrier sets, a subcarrier number contained in each subcarrier set, a sequence length, and a root for generating a sequence.

14. The method according to claim 12, wherein the second frame comprises at least one of the followings:
a user information field, the user information field comprises a resource allocation field, and the first indication information is carried in the resource allocation field;
a trigger type field, the trigger type field being used to indicate that the second frame is used to inquire whether a station device needs to feed back the first status; or
a feedback type field, the feedback type field being used to indicate a feedback type of the second frame, and the feedback type being feedback of the first status.

15. The method according to claim 12, wherein the first indication information is a first resource allocation index, the first resource allocation index is one of a plurality of resource allocation indices, and each of the plurality of resource allocation indices corresponds to one resource allocation.

16. The method according to claim 11, wherein the first sequence being determined based on the identification information of the first station device comprises:
the first sequence is obtained by shifting a basic sequence based on first shift information, wherein the first shift information is determined based on the identification information of the first station device, and the basic sequence is generated based on a root for generating a sequence;
wherein the first shift information and the identification information of the first station device satisfy a second mapping relationship, the second mapping relationship being represented by the following formula:
$$x = ⌊ \frac{AID - starting\_AID}{N} ⌋ ,$$
wherein x represents the first shift information, AID represents the identification information of the first station device, starting_AID represents identification information of a starting station device for which the access point device inquires whether to feed back the first status, and N represents a total quantity of subcarrier sets.

17. The method according to claim 11, wherein index information of the first subcarrier set and the identification information of the first station device satisfy a first mapping relationship, the first mapping relationship being represented by the following formula:
$$RU\_SET \_INDEX = ( AID - starting\_AID ) mod N ,$$
wherein RU_SET_INDEX represents the index information of the first subcarrier set, AID represents the identification information of the first station device, starting_AID represents identification information of a starting station device for which the access point device inquires whether to feed back the first status, and N represents a total quantity of subcarrier sets.

18. The method according to claim 11, wherein the first status indicates that a station device has a pre-emptive transmission requirement or a low-latency data transmission requirement.

19. An apparatus comprising:
a non-transitory memory storage comprising instructions; and
one or more processors in communication with the memory storage, wherein the instructions, when executed by the one or more processors, cause the apparatus to receive a first frame sent by a first station device, the first frame being used to feed back a first status to an access point device; and
determine identification information of the first station device based on a subcarrier set used in a long training field of the first frame and a sequence used in the long training field.

20. A non-transitory readable storage medium configured to store a computer program, wherein the computer program causes a computer to perform the method according to claim 1.
